(19) United States
(12) Patent Application Publication
(10) Pub. No.: US 2019/0377189 A1
(43) Pub. Date: Dec. 12, 2019

(54) HOUSING FOR MOUNTING OF COMPONENTS IN HEAD MOUNTED DISPLAY

(71) Applicant: Microsoft Technology Licensing, LLC, Redmond, WA (US)

(72) Inventors: Brian J. TOLENO, Cupertino, CA (US); Igor MARKOVSKY, San Jose, CA (US); Michael NIKKHOO, Saratoga, CA (US); Joseph Daniel TAYLOR, San Francisco, CA (US); Michael Neil BEERMAN, Mill Valley, CA (US); Marianne Elizabeth LAFORD, Palo Alto, CA (US)

(21) Appl. No.: 16/005,297

(22) Filed: Jun. 11, 2018

(51) Int. Cl. G02B 27/01; H04R 1/02

(52) U.S. Cl. CPC G02B 27/0176; G02B 2027/0178; H04R 1/025; G02B 27/0172

(57) ABSTRACT

A housing, including mounting features for directly mounted components, is formed by curing carbon fiber reinforced polymer (CFRP) and a molding compound (MC) such as a sheet molding compound (SMC) or a bulk molding compound (BMC). SMC or BMC may be used depending on the implementation. This forms a housing with mounting features in a thermoset manner, in which the weight of a product such as a head mounted display (which incorporates the housing comprising the mounting features) is reduced, and any orientation issues or problems are significantly reduced.

### BACKGROUND

Carbon fiber reinforced polymer (CFRP) is a strong and light fiber-reinforced plastic which contains carbon fibers. CFRPs have a low coefficient of thermal expansion (CIE) and a good stiffness to weight ratio, and are commonly used wherever high strength-to-weight ratio and rigidity are required, such as in consumer products and industrial products. CFRPs are composite materials in which the composite consists of two parts: a reinforcement and a matrix. In CFRP, the reinforcement is carbon fiber, which provides the strength, and the matrix is often a polymer resin, such as epoxy, to bind the reinforcements together.

Many consumer products and industrial products that use CFRP structures use bosses, also referred to herein as mounting features, made by doing a second shot of injection molding over the CFRP surface or extruding excess resin from the CFRP itself. Problems with these techniques for sensor and display elements for head mounted displays (HMDs) and other products is the level of dimensional accuracy over temperature and/or the adhesion is not sufficient.

Within the field of wearable devices such as HMDs, many scenarios involve devices with a set of integrated components, such as a helmet or eyewear featuring a display, a processor, an inertial measurement unit, and a battery. The components are often individually mounted to an interior surface of the device, and are interconnected with wires or flex circuits to enable the transfer of power and data among the components. The positions and/or orientations of the components are often carefully selected to promote the functionality of the devices; e.g., a positioning component may be affixed to a location that determines the orientation of the device, but may only be accurate if the actual position and orientation of the mounted positioning component match an expected position and orientation. In such cases, the relative position of the components to one another may be significant as well; e.g., a helmet device may feature two individual displays positioned to present a stereoscopic view to each eye of the user, where even a small divergence in the positions and/or orientation of the displays relative to one another may disrupt the stereoscopic presentation. These and other considerations may make it difficult to design and manufacture devices with integrated components.

### SUMMARY

A housing, including mounting features for directly mounted components, is formed by curing carbon fiber reinforced polymer (CFRP) and a molding compound (MC) such as a sheet molding compound (SMC) or a bulk molding compound (BMC). SMC or BMC may be used depending on the implementation. This forms a housing with mounting features in a thermoset manner, in which the weight of a product such as a head mounted display (which incorporates the housing comprising the mounting features) is reduced, and any orientation issues or problems are significantly reduced.

In an implementation, a method for creating a housing for mounting of components is provided. The method includes disposing a core in a mold, wherein the core comprises a first material and a second material; curing the core such that the first material and the second material are thermoset; and demolding the core from the mold. The first material comprises a CFRP and the second material comprises an MC. The housing comprises a plurality of mounting features for directly mounting a plurality of components, such as optical components, cameras, sensors, and/or displays.

In an implementation, a system for creating a housing for mounting of components is provided. The system includes a first material; a second material; and a mold for receiving a core comprising the first material and the second material and for being compressed and heated to cure the core in a thermoset manner, wherein the cured core is a blank for the housing for direct mounting of components.

In an implementation, a device is provided. The device includes a housing comprising a thermoset material formed by curing a first material and a second material and comprising a plurality of mounting features; and at least one component directly mounted onto at least one of the mounting features. The housing may be a housing for a head mounted display, and the at least one component comprises at least one of a sensor, a camera, and a display.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example scenario featuring a device with an integrated set of electrical components;

FIG. 2 is an illustration of an example head mounted display;

FIG. 3 is a perspective view of an example co-molded molding compound (MC) and carbon fiber reinforced polymer (CFRP) housing;

FIG. 4 is another perspective view of the example co-molded MC and CFRP housing of FIG. 3;

FIG. 5 is a diagram showing an example mold with materials for forming a co-molded MC and CFRP housing;

FIG. 6 is an operational flow of an implementation of a method for creating a co-molded MC and CFRP housing; and

FIG. 7 shows an exemplary computing environment in which example embodiments and aspects may be implemented.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

To maximize the performance benefits of carbon fiber reinforced polymer (CFRP), such as low coefficient of thermal expansion (CIE) and good (high) stiffness to weight ratio, and extend them to consumer and industrial products such as sensors, cameras, and displays mounted directly to a housing, mounting features are formed utilizing highly carbon fiber filled resins known as molding compounds (MCs) (such as sheet molding compounds (SMCs) or bulk molding compounds (BMCs)) during the forming process. SMC or BMC may be used depending on the implementation. In this manner, the weight of the product (which incorporates the housing comprising the mounting features) is reduced, and any orientation issues or problems are significantly reduced.

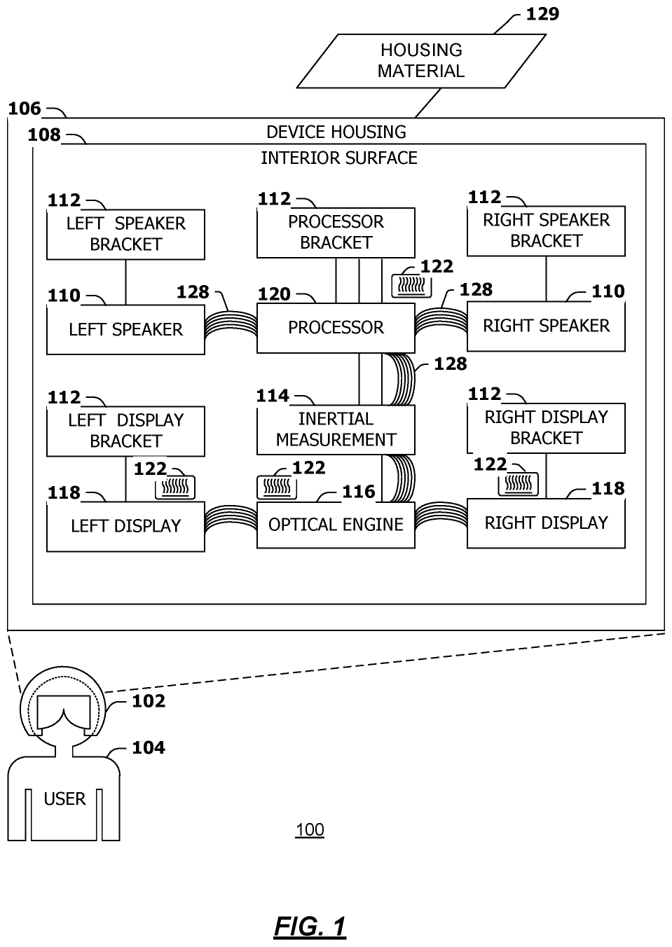

FIG. 1 is an illustration of an example scenario 100 featuring a first device 102 with a set of integrated components. In this example scenario 100, the device 102 comprises a wearable unit, such as a helmet worn on the head of a user 104 to present a virtual environment. The device 102 in this example scenario 100 comprises a device housing 106 with an interior surface 108 onto which are mounted set of components, including a left and right speaker 110 that are positioned within the device housing 106 near a left and right ear of the user 104; a left display 118 and a right display 118 that are positioned within the device housing 106 to present a view of the virtual environment to the left eye and right eye of the user 104; an inertial measurement unit 114; an optical engine 116 that drives video output for the left display 118 and right display 118; and a processor 120 that ties together the other components of the device 102. The respective components may be affixed to the device 102 through individual brackets 112, including a processor bracket 112 that attaches a substrate for the processor 120, the inertial measurement unit 114, and the optical housing 116, and individual brackets 112 for the respective speakers 110 and the displays 118. The components are interconnected with wires 128, such as ribbon cables, that are also mounted to the interior surface 108 to provide insulated electrical conductivity of data and power thereamong. The brackets 112 are mounting features.

In this example scenario 100, electrical current through some of the components of the device 102 generates heat 122. For example, operation of the left speaker 110 and right speaker 110 may not generate significant amounts of heat 122, but the processor 120 may exhibit high computational throughput that dissipates a significant amount of voltage into heat 122, and the optical engine 116 and displays 118 may generate significant amounts of light as well as heat 122. Some heat 122 produced by the components may conduct through the interior surface 108 of the device housing 106 and radiate in 122 to the surrounding environment.

The housing material 129 of the device housing 106 may be chosen based on a variety of design goals, such as reducing the weight of the device 102 (particularly desirable in the case of wearable devices 102); promoting the durability and shock resistance of the device housing 106; and/or reducing the overall cost of the device 102.

As described further herein, the housing material 129, which includes mounting features for the various components, is formed utilizing highly carbon fiber filled resins known as molding compounds (MCs), such as sheet molding compounds (SMCs) or bulk molding compounds (BMCs). SMC or BMC may be used depending on the implementation.

Surface-mounted components may shift in position and/or orientation with respect to the interior surface 108 and/or with respect to one another, particularly over the course of many thermal cycles. Divergence of the position and/or orientation of such components may be highly disadvantageous; e.g., eyewear with dual displays 118 may enable stereoscopic vision only if the position of the displays 118 relative to the eyes of the user 104 is precisely maintained. Distortion of such positioning and/or orientation may cause focal problems that distort the stereoscopic experience and/or induce undesirable side-effects, such as eyestrain, dizziness, nausea, and headaches. Additionally, asymmetric distortion of the housing material 129 (e.g., brackets 112 affixing the components to the interior surface 108) and/or dissipation of heat 122 may damage the device, e.g., through the accumulation of strain, warping, and other damage; detachment of electrical components.

As still another example, the integration of the device 102 as a series of parts—e.g., a bracket (i.e., a mounting feature) that affixes a semiconductor substrate (upon which devices are formed) to the interior surface 108, and wires 128 such as ribbon cables that are separately affixed to the interior surface 108—may increase the number of components within the device housing 106, and/or the variety of such materials. Interfaces between materials of different types may exacerbate the anisotropic properties thereof (e.g., a thermoplastic bracket 112 positioned against a silicon substrate may exhibit different properties than either material alone). Additionally, increasing the number of components within the device housing 106 may increase the complexity, weight, and/or cost of the device 102. No aspect of FIG. 1 is intended to be limiting in any sense, for numerous variants are contemplated as well.

The techniques presented herein may be utilized to produce many types of devices 102 with integrated electrical components. Such devices 102 include wearable devices, such as helmets, eyeglasses, headphones, headsets, earpieces, wristwatches, armbands, necklaces, bracelets, gloves, and footwear. Such devices 102 also include other types of portable devices, such as tablets, mobile phones, portable media players, and portable game consoles.

The techniques presented herein may be utilized with a variety of components that may facilitate the functionality of the device 102. For example, a device 102 such as a helmet that mounts on the head of the user 104 may include such components as a speaker; a display; an inertial measurement unit; a processor; a gaze-tracking camera that tracks the gaze of the user 104; an environment-tracking camera that captures an image of the environment of the device 102; a temperature sensor that senses a temperature of the environment of the device 102; a network adapter that facilitates communication of the device 102 with other devices; and a battery. The components may also support other components of the device 102, such as a memory that serves as a cache for a processor, or a sensor coupled with a light-producing display and integrated in the component cluster with the light-producing display. Many such variations may be identified wherein the techniques presented herein may be utilized.

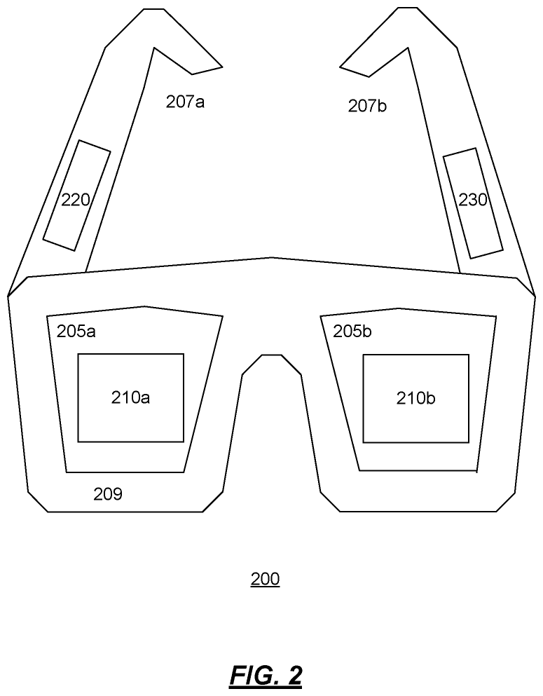

An example of one such device 102 is a head mounted display (HMD). FIG. 2 is an illustration of an example HMD 200. In an implementation, the HMD 200 is a pair of glasses. The HMD 200 includes lenses 205a and 205b arranged within a frame 209. The frame 209 is connected to a pair of temples 207a and 207b. Arranged between each of the lenses 205 and a wearer or user's eyes is a near eye display system 210. The system 210a is arranged in front of a right eye and behind the lens 205a. The system 210b is arranged in front of a left eye and behind the lens 205b. The HMD 200 also includes a controller 220 and one or more sensors 230. The controller 220 may be a computing device operatively coupled to both near eye display systems 210a and 210b and to the sensors 230. A suitable computing device is illustrated in FIG. 7 as the computing device 700.

The sensors 230 may be arranged in any suitable location on the HMD 200. They may include a gyroscope or other inertial sensors, a global-positioning system (“GPS”) receiver, and/or a barometric pressure sensor configured for altimetry. The sensors 230 may provide data on the wearer's location or orientation. From the integrated responses of the sensors 230, the controller 220 may track the movement of the HMD 200 within the wearer's environment.

The sensors 230 may include one or more cameras. The cameras may be configured to acquire video of the surroundings sighted by the wearer. The video may include depth video and may be used to establish the wearer's location, what the wearer sees, etc. The video data may be received by the controller 220, and the controller 220 may be configured to process the video received. The optical axis of the camera may be aligned parallel to, or close to, a line of sight of the wearer of the HMD 200, such that the camera acquires video of the external imagery sighted by the wearer. The nature and number of the cameras may differ in the various embodiments of this disclosure. The one or more cameras may be configured to provide video from which a time resolved sequence of three-dimensional depth map may be obtained via downstream processing

The controller 220 may control the internal componentry of the near eye display systems 210a and 210b to form a desired image frame. In an implementation, the controller 220 may cause the near eye display systems 210a and 210b to display approximately the same image frame concurrently, so that the wearer's right and left eyes receive the same image frame at approximately the same time. In other implementations, the near eye display systems 210a and 210b may project somewhat different image frames concurrently, so that the wearer perceives a stereoscopic, i.e., three-dimensional, image frame.

In some implementations, the computer-generated image frames and various real images of objects sighted through the near eye display systems 210a and 210b may occupy different focal planes. Accordingly, the wearer observing a real world object may shift their corneal focus to resolve the image frame. In other implementations, the image frame and at least one real image may share a common focal plane.

No aspect of FIG. 2 is intended to be limiting in any sense, for numerous variants are contemplated as well. In some embodiments, for example, a vision system separate from the HMD 200 may be used to acquire video of what the wearer sees. In some embodiments, a single near eye display system 210 extending over both eyes may be used instead of the dual monocular near eye display systems 210a and 210b shown in FIG. 2.

The HMD 200 may be configured to run one or more VR applications. A VR application may create a virtual environment that is displayed to the user of HMD 200. While participating in a VR application, the user of the HMD 200 is able to “look around” the virtual environment, move around in it, and interact with one or more virtual objects. In some implementations, one or more VR applications may run on the controller 220 of the HMD 200, and others may run on an external computer accessible to the HMD 200 via one or more wired or wireless communication links. Accordingly, the HMD 200 may include suitable wireless componentry, such as Wi-Fi.

Typical techniques for forming and mounting sensor and display elements for HMDs and other consumer electronics result in dimensional accuracy over temperature and/or the adhesion that is not sufficient. To solve these problems, the housing material and mounting features are formed by curing CFRP and MC together during the forming process.

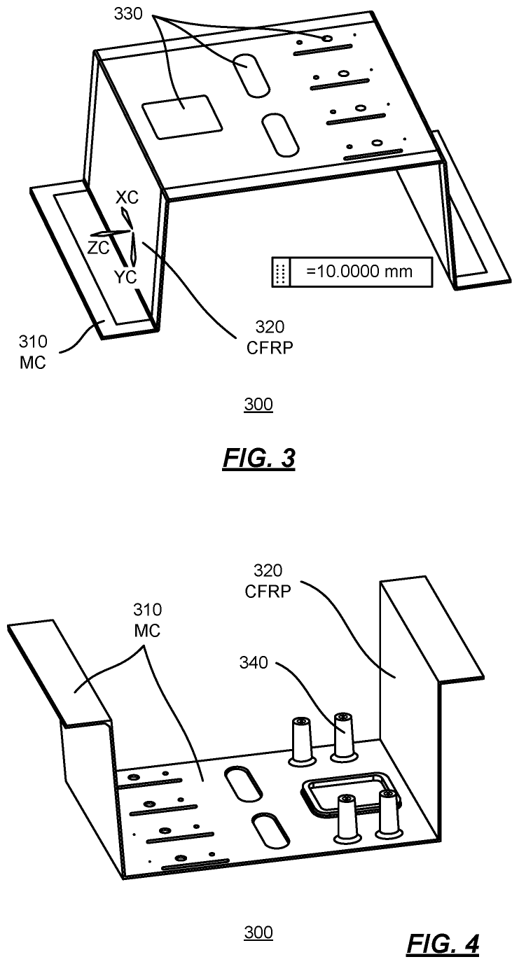

FIG. 3 is a perspective view of an example co-molded MC and CFRP housing 300, and FIG. 4 is another perspective view of the example co-molded MC and CFRP housing 300. The housing 300 may be used in the formation of an HMD, for example. The housing 300 comprises MC 310 and CFRP 320 which is cured together as described further herein. As shown, the housing 300 may be machined before or after formation (molding) to include various cavities 330 that may be used during subsequent processing and manufacturing. In the implementation shown, aluminum columns 340 are also provided in the housing 300 to assist in post-molding machining.

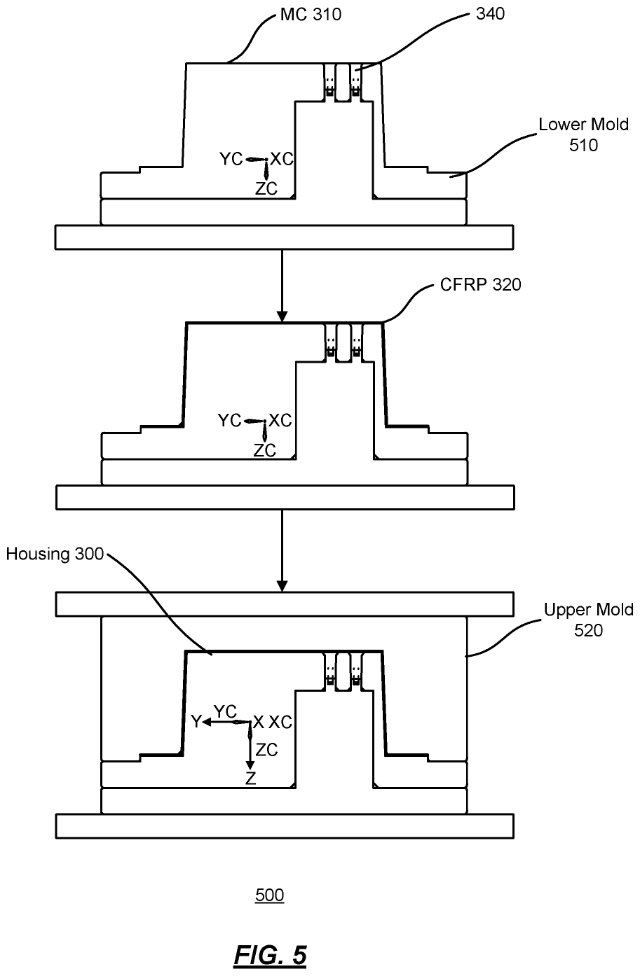

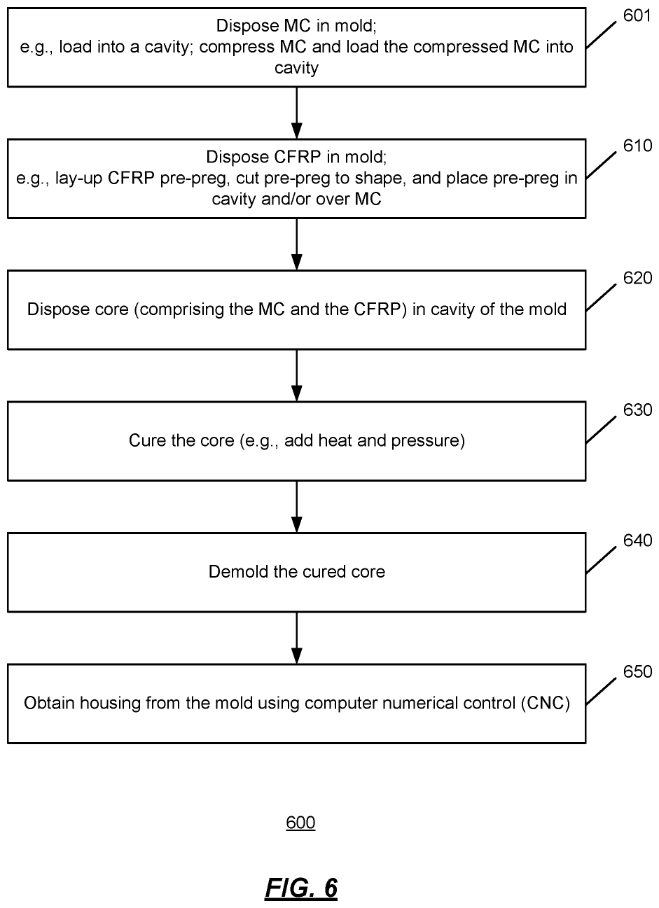

FIG. 5 is a diagram showing an example mold 500 with materials for forming a co-molded MC and CFRP housing. A lower mold 510 receives materials such as a layer of the MC 310 and the aluminum columns 340. The materials may be received by or deposited in a cavity or other molding features in the lower mold 510.

After the MC 310 has been deposited as the layer on the lower mold 310, a layer of the CFRP 320 is deposited on the layer of the MC 310.

After the CFRP 320 layer is deposited, an upper mold 520 is provided to form a complete mold which is then used for curing the MC 310 and the CFRP 320 together (along with the aluminum columns 340 in this example) to form the housing 300. The housing 300 is thus thermoset (not thermoplastic) and has cured as a single product and not as two different materials merely adhering to each other. In this manner, components can be directly mounted to the mounting features of the housing 300, which cannot be performed if the housing was fabricated using injection molding.

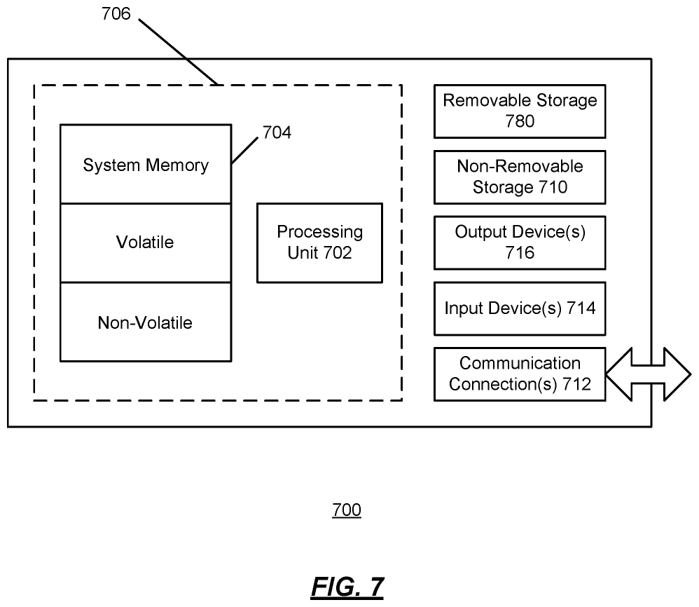

FIG. 6 is an operational flow of an implementation of a method 600 for creating a co-molded MC and CFRP housing 300. At 601, the MC 310 is disposed or otherwise placed or positioned into the mold 500 (e.g., the lower mold 510). In an implementation, the MC 310 can be placed into one or more cavities of the mold 500 (which may be different than the cavities 330). Depending on the implementation, the MC 310 may be compressed prior to loading it into the one or more cavities.

At 610, the CFRP 320 is disposed or otherwise placed or positioned into the mold 500 (e.g., in the form of CFRP pre-preg in which lay-up and cutting may be performed prior to placement in the mold 500). Pre-preg is well known as resin impregnated CFRP sheets. The CFRP 320 may be placed over top of some or all of the MC 310 in the mold 500. In this manner, a core is formed, comprising the uncured MC 310 and the CFRP 320. Note that additional components, such as the aluminum columns 340, may be formed or embedded during the process.

It is contemplated that operations 601 and 610 may be performed in any order depending on the implementation. For example, the CFRP may be placed in the mold (or the cavity of the mold) prior to the MC being placed in the mold. In an implementation, the MC may be placed on the surface of the pre-preg corresponding to cavities in the mold.

At 620, the core is disposed or otherwise placed or positioned in the cavity. In an implementation, the upper mold 520 is placed over the lower mold 510. In this manner, the core may be considered to be disposed in the cavity.

At 630, the curing process is performed in which heat and pressure are applied to the mold 530 and the core. The amount of heat and pressure and time for curing is material-dependent. MC and CFRP often cure at 125 degrees C. or greater, with a pressure of at least 1500 psi, for at least 12 minutes. The core, comprising the MC 310 and the CFRP 320, is thus cured.

The CFRP 320 (e.g., the pre-preg resin) and the MC 310 resin cure together to form a single homogenous polymer network. Structures produced this way exhibit pull forces on the order of 10 to 20 MPa, which is significantly advantageous over polycarbonate structures that are injection molded as a secondary process that have pull forces on the order of 3-5 MPa. Another advantage of the housing with mounting features as formed herein is the low coefficient of thermal expansion (CTE). Unfilled polycarbonate has a CTE of 60 to 80 ppm (depending on vendor and grade). Even polycarbonate with a high degree of filler (glass or carbon), approaches a CTE of 40 ppm. MC materials typically have CTEs in the range of 5 to 25 ppm—significantly lower than thermoplastic materials. This lower CTE translates into a higher degree of stability over different temperature ranges for objects and devices mounted to a structure using these types of materials. Thus, the enclosure with mounting features is more temperature stable and stronger than injection molded enclosures and mounting features.

At 640, demolding is performed such that the cured core is removed from the mold 500. The demolded cure may be considered to be a blank for the housing. The blank can be processed to obtain the housing. At 650, the demolded core is processed using computer numerical control (CNC) to obtain the housing 300. Subsequent machining and further processing, including component mounting, may be performed on the housing 300. Components that may be directly mounted include, but are not limited to, sensors, cameras, and displays.

In an implementation, before the molding process, MC may be placed in areas on the surface of the pre-preg corresponding to cavities on the mold. During the molding process, the MC material flows into the cavity of the mold forming the boss/mounting feature.

In another implementation, the MC may be manually or automatically loaded into a cavity on the mold.

In another implementation, the MC may be compressed in a separate process, and then this compressed (but not cured) material may be manually or automatically loaded into a cavity on the mold.

A technical effect that may be achieved by the techniques presented herein involves the positioning and/or orientation of the components mounted to the interior surface 108, both with respect to one another and with respect to the interior surface 108. Distortion of the molecular structure of the housing material 129 may displace the position and/or orientation of the components of the device 102, including the relative position and/or orientation between a first component and a second component. For example, changing the relative position and/or orientation of the left display 118 and the right display 118 may disrupt the stereoscopic presentation of the virtual environment. Even a small displacement of the rotation and/or lateral position of one or both displays 118 may be noticeable and distracting, while a more substantial displacement may induce eyestrain, dizziness, nausea, and headaches. More extensive displacement of the components may result in dislodging or separation from the interior surface 108. The use of the techniques presented herein to form the housing material 129 from thermoset cured CFRP and MC materials may reduce the displacement of the components of the device 102, and may therefore extend the long-term durability and functionality of the device 102.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

In an implementation, a method for creating a housing for mounting of components is provided. The method includes disposing a core in a mold, wherein the core comprises a first material and a second material; curing the core such that the first material and the second material are thermoset; and demolding the core from the mold.

Implementations may include some or all of the following features. The first material comprises a carbon fiber reinforced polymer and the second material comprises a molding compound. Disposing the core in a mold comprises disposing the first material in the mold and disposing the second material over the first material in the mold. The first material comprises a molding compound and the second material comprises a carbon fiber reinforced polymer pre-preg that has undergone lay-up and cutting to shape. Disposing the first material in the mold comprises loading the first material into a cavity of the mold. One of the first material or the second material comprises a molding compound disposing the molding compound in the mold comprises compressing the molding compound and loading the compressed molding compound into the mold. The method may further comprise obtaining the housing from the demolded core using computer numerical control. The housing comprises a plurality of mounting features for directly mounting a plurality of components. The plurality of components comprise optical components. The plurality of components comprise at least one of a sensor, a camera, and a display.

In an implementation, a system for creating a housing for mounting of components is provided. The system includes a first material; a second material; and a mold for receiving a core comprising the first material and the second material and for being compressed and heated to cure the core in a thermoset manner, wherein the cured core is a blank for the housing for direct mounting of components.

Implementations may include some or all of the following features. The first material comprises a carbon fiber reinforced polymer and the second material comprises a molding compound. The mold comprises a lower mold on which the core is disposed, and an upper mold which covers the core and the lower mold. The lower mold comprises a cavity for receiving the first material and for receiving the second material on top of at least a portion of the first material. The first material comprises a molding compound and the second material comprises a carbon fiber reinforced polymer pre-preg that has undergone lay-up and cutting to shape. One of the first material or the second material comprises a compressed molding compound

In an implementation, a device is provided. The device includes a housing comprising a thermoset material formed by curing a first material and a second material and comprising a plurality of mounting features; and at least one component directly mounted onto at least one of the mounting features.

Implementation may have some or all of the following features. The first material comprises a carbon fiber reinforced polymer and the second material comprises a molding compound. The at least one component comprises at least one optical component. The housing is a housing for a head mounted display, and the at least one component comprises at least one of a sensor, a camera, and a display.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for creating a housing for mounting of components, the method comprising:
disposing a core in a mold, wherein the core comprises a first material and a second material;
curing the core such that the first material and the second material are thermoset; and
demolding the core from the mold.

2. The method of claim 1, wherein the first material comprises a carbon fiber reinforced polymer and the second material comprises a molding compound.

3. The method of claim 1, wherein disposing the core in a mold comprises disposing the first material in the mold and disposing the second material over the first material in the mold.

4. The method of claim 3, wherein the first material comprises a molding compound and the second material comprises a carbon fiber reinforced polymer pre-preg that has undergone lay-up and cutting to shape.

5. The method of claim 3, wherein disposing the first material in the mold comprises loading the first material into a cavity of the mold.

6. The method of claim 3, wherein one of the first material or the second material comprises a molding compound, and disposing the molding compound in the mold comprises compressing the molding compound and loading the compressed molding compound into the mold.

7. The method of claim 1, further comprising obtaining the housing from the demolded core using computer numerical control.

8. The method of claim 7, wherein the housing comprises a plurality of mounting features for directly mounting a plurality of components.

9. The method of claim 8, wherein the plurality of components comprises optical components.

10. The method of claim 8, wherein the plurality of components comprises at least one of a sensor, a camera, and a display.

11. A system for creating a housing for mounting of components, the system comprising:
a first material;
a second material; and
a mold for receiving a core comprising the first material and the second material and for being compressed and heated to cure the core in a thermoset manner, wherein the cured core is a blank for the housing for direct mounting of components.

12. The system of claim 11, wherein the first material comprises a carbon fiber reinforced polymer and the second material comprises a molding compound.

13. The system of claim 11, wherein the mold comprises a lower mold on which the core is disposed, and an upper mold which covers the core and the lower mold.

14. The system of claim 13, wherein the lower mold comprises a cavity for receiving the first material and for receiving the second material on top of at least a portion of the first material.

15. The system of claim 14, wherein the first material comprises a molding compound and the second material comprises a carbon fiber reinforced polymer pre-preg that has undergone lay-up and cutting to shape.

16. The system of claim 11, wherein one of the first material or the second material comprises a compressed molding compound.

17. A device comprising:
a housing comprising a thermoset material formed by curing a first material and a second material and comprising a plurality of mounting features; and
at least one component directly mounted onto at least one of the mounting features.

18. The device of claim 17, wherein the first material comprises a carbon fiber reinforced polymer and the second material comprises a molding compound.

19. The device of claim 17, wherein the at least one component comprises at least one optical component.

20. The device of claim 17, wherein the housing is a housing for a head mounted display, and wherein the at least one component comprises at least one of a sensor, a camera, and a display.
